(19) United States
(12) Patent Application Publication
(10) Pub. No.: US 2013/0029233 A1
(43) Pub. Date: Jan. 31, 2013

(54) METHOD FOR PREPARING MnO2/CARBON COMPOSITE, MNO2/CARBON COMPOSITE PREPARED BY THE METHOD, AND LITHIUM-AIR SECONDARY BATTERY INCLUDING THE COMPOSITE

(71) Applicants: Ho Taek Lee, Seoul (KR); Kyoung Han Ryu, Yongin (KR); Yongsug Tak, Incheon (KR); Sung-Hyeon Baeck, Incheon (KR); Jinsub Choi, Incheon (KR); Ku Bong Chung, Gongju (KR); Tae Young Jang, Namwon (KR)

(72) Inventors: Ho Taek Lee, Seoul (KR); Kyoung Han Ryu, Yongin (KR); Yongsug Tak, Incheon (KR); Sung-Hyeon Baeck, Incheon (KR); Jinsub Choi, Incheon (KR); Ku Bong Chung, Gongju (KR); Tae Young Jang, Namwon (KR)

(73) Assignees: Inha-Industry Partnership Institute, Incheon (KR); Hyundai Motor Company, Seoul (KR)

(21) Appl. No.: 13/274,656

(22) Filed: Oct. 17, 2011

(30) Foreign Application Priority Data
Jul. 28, 2011 (KR) 10-2011-0074885

(51) Int. Cl. H01M 4/90; B05D 5/12; B01J 31/32

(52) U.S. Cl. 429/405; 502/159; 427/58

(57) ABSTRACT

Disclosed is a method for preparing an MnO₂/carbon composite for a lithium-air secondary battery by preparing a precursor solution by dissolving permanganate powder in distilled water, preparing a MnO₂/carbon composite by dispersing carbon in the precursor solution and using a reducing agent, and mixing the MnO₂/carbon composite with polyvinylidene fluoride (PVdF) and supporting the mixture on nickel foam. According to the method for preparing a MnO₂/carbon composite for a lithium-air secondary battery, the MnO₂/carbon composite is prepared by dispersing carbon in a permanganate solution, instead of simply mixing carbon with manganese oxide, and thus the binding force between carbon and manganese oxide and the dispersion of carbon in manganese oxide can increase. The MnO₂/carbon composite prepared by the above method has improved catalytic performance as an air electrode for a lithium-air secondary battery and thus can be effectively used as an electrode material for lithium-air secondary batteries.

### CROSS-REFERENCE TO RELATED APPLICATION

This application claims under 35 U.S.C. §119(a) the benefit of Korean Patent Application No. 10-2011-0074885 filed Jul. 28, 2011, the entire contents of which are incorporated herein by reference.

### BACKGROUND

(a) Technical Field

The present invention relates to a lithium-air secondary battery. More particularly, the present invention relates to a method for preparing a MnO₂/carbon composite by precipitation, a MnO₂/carbon composite prepared by the method, and a lithium-air secondary battery including the composite, which has a low overvoltage and increased charge/discharge characteristics (or cyclability).

(b) Background Art

With increasing public concerns over environmental pollution issues worldwide, there has been extensive research aimed at developing alternative energy. As a means of alternative energy, the importance of metal-air electrochemical cells, especially, lithium-air secondary batteries has increased.

These metal-air electrochemical cells have a high energy density, can be charged and recharged, and have a high specific energy capacity of about 3,000 Whkg⁻¹. This metal-air cell uses an electrolyte, a metal anode, and an air cathode using a catalyst. A lithium anode electrochemically reacts with oxygen in the air through an air cathode. Oxygen in the air electrode is supplied from the air, and thus the metal-air cell has a high energy density. Most of metal-air cells use an aqueous electrolyte, and among them, zinc-air cells have been proposed as a possible solution.

The theoretical capacity of the metal-air cells is 3,842 mAhg⁻¹, 2,965 mAhg⁻¹, and 815 mAhg⁻¹ with respect to lithium, aluminum, and zinc, respectively. The electromotive force of a lithium-air cell is 3.72 V in an acidic solution and 2.982 V in a basic solution. However, there are practical difficulties in commercializing the lithium-air cells due to corrosion of lithium anode, decomposition of aqueous electrolyte, etc.

The electrode reactions in a typical lithium-air cell can be represented by the following formulas:

Reaction in the anode: Li(s) [symbol] Li⁺+e⁻

Reaction in the cathode: Li⁺+1/2O₂+e⁻ [symbol] 1/2Li₂O₂(s)

Li⁺+1/4O₂+e⁻ [symbol] 1/2Li₂O(s)

The reaction in the anode takes place in the reverse. Two reactions take place in the cathode, in which the reversible cell voltage is 2.959 V and 2.013 V, respectively. The reversibility of the two reactions may vary under given conditions. The current density of the lithium-air cell may be as high as 250 mAg⁻¹. This high current density is related to the amount of carbon used. The lower the amount of carbon used, the higher the energy capacity. If the current density and the amount of carbon used are constant, the higher the oxygen mobility, the more the energy capacity increases. Therefore, it is important to maintain a high oxygen mobility while increasing the amount of carbon used.

The electrochemical reaction at the cathode in an aqueous electrolyte is completely different from that in a non-aqueous electrolyte. To prevent the wetting of carbon, the electrolyte should have high polarity, which can prevent the electrolyte from leaking, thereby improving the performance.

An anode is typically made of lithium metal, and the formation of aqueous lithium metal may cause a short circuit between two electrodes. To prevent the short circuit, it is necessary to separate the anode from the liquid electrolyte, and further, it is important to prevent water and oxygen from reaching the anode. In the non-aqueous electrolyte, the solubility and diffusion coefficient of oxygen are important. To optimize the solubility and diffusion coefficient of oxygen, it is beneficial to determine an appropriate mixed solvent, an appropriate lithium salt, and an appropriate amount of electrolyte that can optimize the wetting of carbon. Further, the performance of the lithium-air cell depends on the air cathode.

In the non-aqueous electrolyte, lithium oxide generated during discharge is often not dissolved in the electrolyte, as opposed to the aqueous electrolyte. The lithium oxide generated during discharge often clogs the air electrode. If an air electrode is completely clogged, the oxygen in the air is no longer reduced, thereby deteriorating the cycle characteristics.

An air electrode of the lithium-air cell is mainly formed of an inexpensive oxide catalyst in which porous carbon having a large surface area is used as catalyst support to facilitate the reaction with oxygen in the air. The catalyst of the air electrode functions to increase the capacitance, reduce the overvoltage of the cell, and improve the cycle characteristics of the cell. Until now, manganese oxide catalysts have the most appropriate performance and price and offer decent performance compared to the catalysts using only carbon. Manganese oxide has various phases such as α-, β-, γ-, λ-, etc., and thus the discharge characteristics are different for each phase.

However, cathodes often deteriorate quicker than most consumers and automotive manufactures would like. Typically, the deterioration of the cathode is often caused by continuous deposition of irreversibly produced Li₂O in pores. When MnO₂ and carbon are simply mixed together, there are high overvoltage problems and poor charge characteristics of the lithium-air cells.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an air electrode catalyst for implementing a lithium-air secondary battery with improved charge/discharge characteristics (or cyclability) and a method for preparing a MnO₂/carbon composite by dispersing carbon in a permanganate solution. The present invention also provides an MnO₂/carbon composite prepared by the above-described method and a lithium-air secondary battery including the MnO₂/carbon composite as an air electrode.

In one aspect, the present invention provides a method for preparing a MnO₂/carbon composite for a lithium-air secondary battery, the method including the steps of: (1) preparing a permanganate solution by dissolving permanganate powder in a solvent; (2) preparing an MnO₂/carbon composite by dispersing carbon in the permanganate solution prepared in step (1) and using a reducing agent; and (3) mixing the MnO₂/carbon composite prepared in step (2) with polyvinylidene fluoride (PVdF) and supporting the mixture on nickel foam.

In another aspect, the present invention provides a MnO₂/carbon composite prepared by the method. In still another aspect, the present invention provides a lithium-air secondary battery comprising the MnO₂/carbon composite as an air electrode.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows transmission electron microscope images of a MnO₂/carbon composite prepared in Example 1 of the present invention, in which the left image is a high magnification TEM image of the MnO₂/carbon composite and the right image is a low magnification TEM image of the MnO₂/carbon composite;

FIG. 2 is a graph showing the results of X-ray diffraction analysis of the MnO₂/carbon composite prepared in Example 1 of the present invention;

FIG. 3A is a graph showing the analysis results of cyclability of a lithium-air secondary battery prepared using the MnO₂/carbon composite prepared in Example 1 of the present invention as an air electrode; and

FIG. 3B is a graph showing the analysis results of cyclability of a lithium-air secondary battery prepared using a catalyst prepared by simply mixing MnO₂ with carbon in Comparative Example 1 as an air electrode.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

A method for preparing a MnO₂/carbon composite for a lithium-air secondary battery in accordance with a preferred embodiment of the present invention includes the steps of: (1) preparing a permanganate solution by dissolving permanganate powder in a solvent; (2) preparing a MnO₂/carbon composite by dispersing carbon in the permanganate solution prepared in step (1) and using a reducing agent; and (3) mixing the MnO₂/carbon composite prepared in step (2) with polyvinylidene fluoride (PVdF) and supporting the mixture on nickel foam.

The permanganate used in step (1) may be potassium permanganate, sodium permanganate, or barium permanganate, and preferably, potassium permanganate. The solvent used in step (1) may be water. The reducing agent used in step (2) may be C₁-C₆ alcohol. Preferably, the weight ratio of the permanganate solution to the carbon used in step (2) may be about 10:13 to 11:13. The MnO₂/carbon composite prepared by the method may be used as an air electrode of a lithium-air secondary battery.

In order to examine the performance of the air electrode of the lithium-air secondary battery prepared using the MnO₂/carbon composite as a catalyst prepared according to the present invention, a Swagelok type cell was used. The cell was assembled in a box filled with argon gas, a lithium metal (Sigma Aldrich, approximately 0.38 mm in thickness) was used as an anode, and 1M LiPF6 in PC:EC:DEC was used as an electrolyte. The electrolyte was supported by a glass fiber separator (Whatman, GF/D), and the synthesized catalyst and polyvinylidene fluoride (PVdF) were mixed in a mass ratio of about 95:5, supported on nickel foam, and used as a cathode. During charge/discharge cycle, an oxygen atmosphere was maintained.

Next, the present invention will be described in more detail with reference to the Examples and drawings.

### Example 1

### Preparation of Air Electrode for Lithium-Air Secondary Battery Using MnO₂/Carbon Composite

Step (1): Preparation of Potassium Permanganate Solution Using Potassium Permanganate (KMnO₄) Powder

Potassium permanganate (KMnO₄) powder weighing 0.778 g was placed in a 50 mL beaker, 30 mL of distilled water was added to the beaker, and then the resulting mixture was stirred for about 30 minutes, thereby completely dissolving the solute.

Step (2): Preparation of MnO₂/Carbon Composite

Ketjen black carbon weighing 1.0 g was added to the potassium permanganate solution prepared in step (1) and stirred for 2 hours. 10 mL of ethanol as a reducing agent was added to the resulting mixture at a constant flow rate of 2 mL/hour using a syringe pump, stirred for 24 hours, and subjected to filtering and water-washing, thus obtaining a MnO₂/carbon composite having 30 wt % MnO₂.

Step (3): Preparation of Air Electrode for Lithium/Air Secondary Battery

19 mg of MnO₂/carbon composite powder prepared in step (2) and polyvinylidene fluoride (PVdF) weighing approximately 1 mg were placed in a 5 ml beaker, 1.5 mL of N-methyl-2-pyrrolidone (NMP) was added to the beaker, and the resulting mixture was subjected to ultrasonication for about 30 minutes. Nickel foam was immersed in the prepared electrolyte solution and subjected to ultrasonication for about 30 minutes, and the resulting nickel foam was dried in an oven at approximately 60° C. for about 24 hours, thereby preparing an air electrode for a lithium-air secondary battery.

### Comparative Example 1

### Preparation of Air Electrode for Lithium-Air Secondary Battery Using Mixture Prepared by Simply Mixing MnO₂ and Carbon

Step (1): Preparation of Permanganate Solution Using Potassium Permanganate (KMnO₄) Powder

This step was performed in the same manner as Example 1.

Step (2): Preparation of Manganese Dioxide (MnO₂)

10 mL of ethanol as a reducing agent was added to the permanganate solution prepared in step (1) at a constant flow rate of 2 mL/hour using a syringe pump, stirred for about 24 hours, and subjected to filtering and water-washing, thus obtaining manganese dioxide (MnO₂).

Step (3): Preparation of Air Electrode for Lithium-Air Secondary Battery

5.7 mg of manganese dioxide (MnO₂) powder prepared in step (2) and 13.3 mg of ketjen black carbon (the mass ratio of carbon to MnO₂ is 70:30) and 1 mg of polyvinylidene fluoride (PVdF) were placed in a 5 ml beaker, 1.5 mL of N-methyl-2-pyrrolidone (NMP) was added to the beaker, and the resulting mixture was subjected to ultrasonication for about 30 minutes. Nickel foam was immersed in the prepared electrolyte solution and subjected to ultrasonication for about 30 minutes, and the resulting nickel foam was dried in an oven at 60° C. for 24 hours, thereby preparing an air electrode for a lithium-air secondary battery.

### Test Example 1

### Analysis of Properties of the Synthesized MnO₂/Carbon Composite

1. Transmission Electron Microscopy Observation

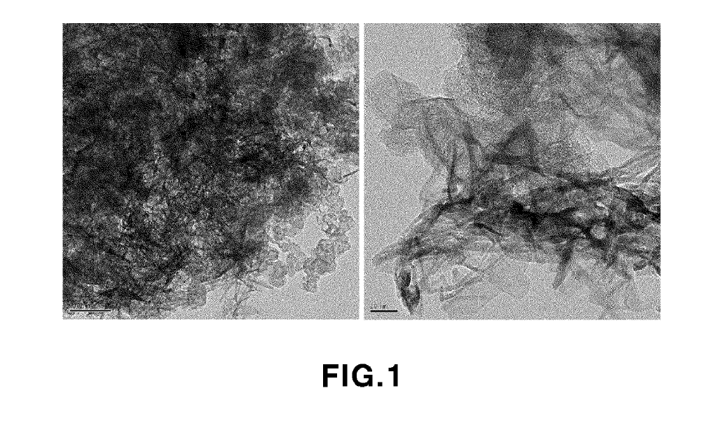

A transmission electron microscope (TEM) was used to analyze the shape of MnO₂/carbon composite particles prepared in Example 1 of the present invention, and the results are shown in FIG. 1.

As shown in FIG. 1, it can be seen that MnO₂ in the form of nanorods was supported on ketjen black carbon of 20 nm.

2. X-Ray Diffraction Analysis

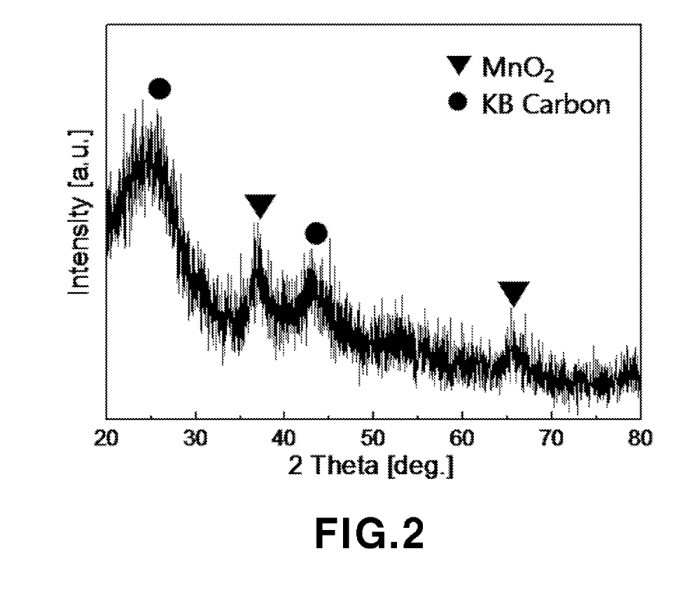

X-ray diffraction analysis was performed to determine the formation of manganese oxide structures of the MnO₂/carbon composite according to the present invention, and the results are shown in FIG. 2. As shown in FIG. 2, the characteristic peaks of ketjen black carbon were observed at about 25 degrees and 43 degrees and the characteristic peaks of MnO₂ were observed at about 37 degrees and 66 degrees in Example 1, from which it can be seen that MnO₂ was formed.

### Test Example 2

### Charge/Discharge Test on Lithium-Air Secondary Battery Using Air Electrode Comprising MnO₂/Carbon Composite and that Using Air Electrode Comprising Catalyst Prepared by Simply Mixing MnO₂ and Carbon

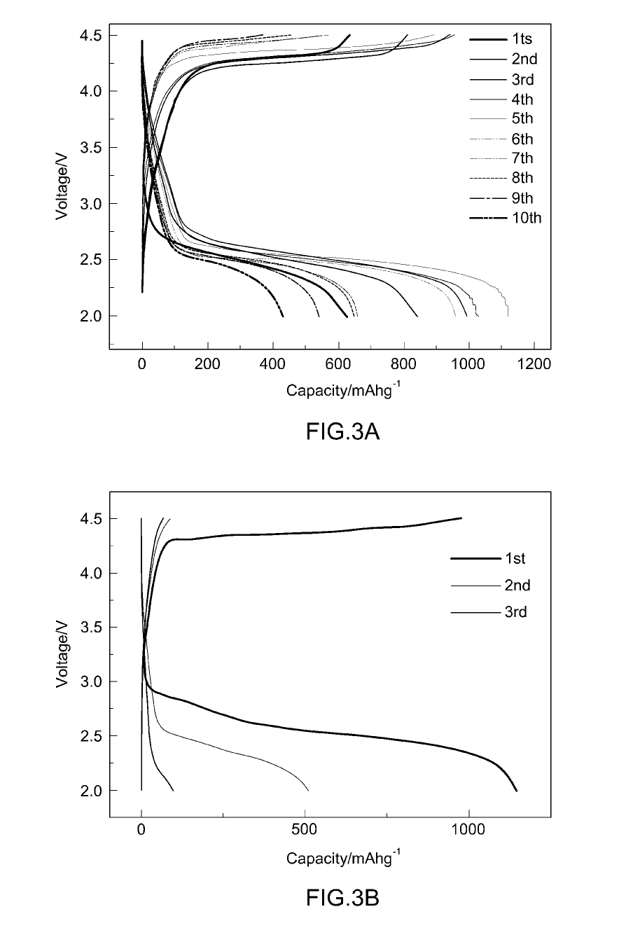

A charge/discharge test was performed on the lithium-air secondary batteries prepared using the air electrodes in Example 1 and Comparative Example 1 to determine the performance of the catalyst as the air electrode for the lithium-air secondary battery, and the results are shown in FIG. 3. When comparing the catalyst in Example 1 with the catalyst in Comparative Example 1 through the charge/discharge test, it can be seen that the lithium-air secondary battery using the catalyst in Example 1 had more improved cyclability than the lithium-air secondary battery using the catalyst in Comparative Example 1 (refer to FIGS. 3A and 3B).

As described above, the MnO₂/carbon composite prepared by dispersing carbon in a permanganate solution according to the present invention exhibits improved performance such as cyclability, compared to a mixture prepared by simply mixing MnO₂ with carbon, and thus it can be seen that the MnO₂/carbon composite according to the present invention can be effectively used as an electrode material for lithium-air secondary batteries with superior benefits to those electrodes previously used.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for preparing a MnO₂/carbon composite for a lithium-air secondary battery, the method comprising the steps of:
(1) preparing a permanganate solution by dissolving permanganate powder in a solvent;
(2) preparing a MnO₂/carbon composite by dispersing carbon in the permanganate solution prepared in step (1) and using a reducing agent; and
(3) mixing the MnO₂/carbon composite prepared in step (2) with polyvinylidene fluoride (PVdF) and supporting the mixture on nickel foam.

2. The method of claim 1, wherein the permanganate used in step (1) is potassium permanganate, sodium permanganate, or barium permanganate.

3. The method of claim 1, wherein the solvent used in step (1) is water.

4. The method of claim 1, wherein the reducing agent used in step (2) is C₁-C₆ alcohol.

5. The method of claim 1, wherein the weight ratio of the permanganate solution to the carbon used in step (2) is 10:13 to 11:13.

6. A MnO₂/carbon composite prepared by:
(1) preparing a permanganate solution by dissolving permanganate powder in a solvent;
(2) preparing a MnO₂/carbon composite by dispersing carbon in the permanganate solution prepared in step (1) and using a reducing agent; and
(3) mixing the MnO₂/carbon composite prepared in step (2) with polyvinylidene fluoride (PVdF) and supporting the mixture on nickel foam.

7. A lithium-air secondary battery comprising the MnO₂/carbon composite as an air electrode wherein the MnO₂/carbon composite includes a permanganate solution prepared by dissolving permanganate powder in a solvent, carbon dispersed in the permanganate solution and a reducing agent, polyvinylidene fluoride (PVdF) and supported on nickel foam.
